(19) United States
(12) Patent Application Publication
(10) Pub. No.: US 2025/0385029 A1
(43) Pub. Date: Dec. 18, 2025

(54) MG-CONTAINING HIGH-PERFORMANCE NEODYMIUM-IRON-BORON MAGNET AND PREPARATION METHOD THEREFOR

(71) Applicant: ZHEJIANG INNUOVO MAGNETICS CO., LTD., Dongyang, Zhejiang Province (CN)

(72) Inventors: XIAOHANG ZHU, DONGYANG, ZHEJIANG PROVINCE (CN); SONG FU, DONGYANG, ZHEJIANG PROVINCE (CN); KANG GAO, DONGYANG, ZHEJIANG PROVINCE (CN); ZHAONENG ZHANG, DONGYANG, ZHEJIANG PROVINCE (CN); XIAOLU YANG, DONGYANG, ZHEJIANG PROVINCE (CN); HONGPING WU, DONGYANG, ZHEJIANG PROVINCE (CN)

(21) Appl. No.: 18/878,625

(22) PCT Filed: May 25, 2023
(86) PCT No.: PCT/CN2023/096176

§ 371 Date: Dec. 23, 2024

(30) Foreign Application Priority Data
Dec. 6, 2022 (CN) 202211557796.1

(51) Int. Cl. H01F 1/057; H01F 41/02

(52) U.S. Cl. CPC H01F 1/0577; H01F 41/0266

(57) ABSTRACT

Disclosed is an Mg-containing high-performance neodymium-iron-boron magnet, comprising the following components in percentages by mass: 29.0 wt. %-32.0 wt. % of R, wherein R is one or more selected from rare earth elements and contains at least one of Nd or Pr; 0.05 wt. %-2.0 wt. % of M1, wherein M1 is one or more of Al, Mn, Nb, Ti, W, Hf, Zr or Cr; 0.2 wt. %-1.0 wt. % of M2, wherein M2 is Ga or Ga and Cu; 0.85 wt. %-0.96 wt. % of B; 0.0005 wt. %-0.002 wt. % of Mg; and the balance of T, wherein T is Fe or Fe and Co, and 90% or more of T is Fe. A phase region rich in Mg and Ga exists in a triangular grain boundary region among the magnet main phase R₂T₁₄B, wherein the content of Mg is 0.05 wt. %-0.5 wt. %, the content of Ga is 3.0 wt. %-6.0 wt. %, and the mass ratio of Mg to Ga in the triangular grain boundary region is smaller than or equal to 10. In the present disclosure, in an R-T-B series rare earth permanent magnet, by adding a specified amount of Mg and an appropriate amount of Cu and Ga, the residual magnetism and coercivity of the magnet are enhanced, and the squareness of the magnet is significantly improved.

### TECHNICAL FIELD

The present disclosure relates to a preparation method for a Mg-containing R-T-B-based high-performance sintered neodymium-iron-boron magnet.

### BACKGROUND TECHNOLOGY

Sintered R-T-B magnets are the third-generation permanent magnets. Since they were invented by Japanese scholars in 1983, they are widely used in fields such as communication, medicine, automotive, electronics, and aviation due to their excellent magnetic properties and high cost-effectiveness. Especially with the increasing national requirements for energy conservation and environmental protection, they have been more widely applied in new energy sectors such as wind power generation and pure electric vehicles. As technology progresses, the requirements regarding the comprehensive capabilities of neodymium-iron-boron magnets in various fields are reaching ever-higher levels. In recent years, the continuous rise in the prices of rare earth, especially heavy rare earth raw materials, has made the development of low-heavy-rare-earth-cost and high-performance neodymium-iron-boron materials an urgent technical challenge requiring a solution.

The typical performance indicators of R-T-B magnets are residual magnetism and coercivity, which are influenced by many factors and possess complex mechanisms. In terms of material structure, R-T-B-based magnets are mainly composed of a Nd₂Fe₁₄B main phase and grain boundary phases which are rich in rare earth or B. The main phase determines the magnet's principal performance. The presence of the rare earth-rich phase can enhance magnet densification and, when distributed along grain boundaries, can eliminate magnetic coupling, thereby enhancing the coercivity and squareness.

Patent Document 1 (CN 105658835 B) discloses a low-B rare earth magnet aimed at improving the squareness of the magnet. The magnet contains Cu: 0.3-0.8 at % and Co: 0.3-3 at %. During the sintering process, high Cu phase, low Cu phase, and medium Cu phase crystals were formed in the grain boundary, enhancing the squareness of the magnet and improving its demagnetization resistance. However, an excessive content of Cu could lead to a decrease in its coercivity. In embodiments, without adding heavy rare earths, most of its Hcj was less than 16 kOe; and when the content of Co was low, the temperature resistance of the magnet was poor.

Patent Document 2 (CN 106024254 A) discloses a low-B neodymium-iron-boron magnet, which has a M2 boride phase at grain boundary triple junctions and no B-rich phase, and discloses that the grain boundary phase contains a R-Fe (Co)-M1 phase and/or a R-M1 phase, with a grain boundary phase width of at least ≥10 nm and an average of ≥50 nm, achieving a favorable magnetic isolation effect and high coercivity. Nevertheless, it was not possible to obtain a high Br at the same time, nor is it possible to further obtain a good squareness index.

Adding a small amount of Cu or Ga can enhance the wettability of the grain boundary, thereby increasing coercivity, but there would be a significant decrease in residual magnetism. Due to the low melting point and easy oxidation of a rare earth grain boundary phase rich in Cu and Ga, the effective content would decrease throughout the entire preparation process. At the same time, Cu and Ga accelerate the enrichment phase transition of the grain boundary phase, which increases the difficulty of control, and thus special hydrogen decrepitation processes or more stringent sintering aging conditions are required.

### SUMMARY OF THE INVENTION

The object of the present disclosure is to overcome the shortcomings of the existing technology and provide a high-performance R-T-M1-M2-B—Mg-based neodymium-iron-boron magnet containing a trace amount of Mg element and a preparation method therefor.

The present disclosure is implemented through the following technical solutions:
a Mg-containing high-performance neodymium-iron-boron magnet, the raw material composition of the magnet comprises the following components in percentage by mass:
29.0 wt. %-32.0 wt. % of R, wherein R is one or more selected from rare earth elements and contains at least one of Nd or Pr;
0.05 wt. %-2.0 wt. % of M1, wherein M1 is one or more of Al, Mn, Nb, Ti, W, Hf, Zr or Cr;
0.2 wt. %-1.0 wt. % of M2, wherein M2 is Ga or Ga and Cu;
0.85 wt. %-0.96 wt. % of B;
0.0005 wt. %-0.002 wt. % of Mg;
the balance of T, wherein T is Fe or Fe and Co, and 90% or more of T is Fe; and
other inevitable impurities.

The Mg-containing high-performance neodymium-iron-boron magnet satisfies the following relationship:

$$14 [ B ] / 1 0.8 ⩽ [ T ] / 55.85$$

wherein [B] is the content of B expressed in mass %, and [T] is the content of T expressed in mass %.

Mg can form five non-ferromagnetic compounds with Ga at a grain boundary: Ga₂Mg₅, GaMg₂, GaMg, Ga₂Mg, and Ga₅Mg₂, wherein Ga₂Mg₅, GaMg, and Ga₂Mg are molten with the same solid-liquid composition at 470° C., 370° C., and about 283° C., respectively. This can effectively improve the wettability of the grain boundary, form a continuous grain boundary compound, and enhance the effect of removing magnetic coupling at the grain boundary in the magnet, thereby improving the coercivity and squareness of the magnet.

Mg, as a non-ferromagnetic substance, when added in a trace amount to the magnet, will not enter the main phase, avoiding the decrease of the magnetic performance of the magnet due to the dilution of the magnetic performance of the magnet. In addition, the free energy of Nd, Pr, Ga, etc. to form oxides is equivalent to that of Mg. The addition of Mg can effectively increase the effective content of rare earth elements in the grain boundary, which is beneficial to improve the coercivity of the magnet. The oxide generated simultaneously has the characteristics of structural stability and high melting point, and is dispersed in the grain boundary, which not only inhibits grain growth and further improves the density and residual magnetism of the magnet, but also has a certain pinning effect, which is conducive to the improvement of the coercivity of the magnet.

It should be noted that during the manufacturing process, a small amount of O, C, N, and other impurities are inevitably mixed into the magnet. The O and N elements mixed easily combine with rare earth elements, thereby reducing the effective rare earth content in the magnet, leading to deterioration of the coercivity and squareness of the magnet. The mixing of C element can lead to abnormal grain growth of the magnet during the sintering process, resulting in deterioration of the coercivity.

Therefore, in the Mg-containing high-performance neodymium-iron-boron magnet, the content of oxygen is controlled below 1500 ppm, and more preferably below 1000 ppm, the content of C is controlled below 1200 ppm, preferably below 1000 ppm, and more preferably below 800 ppm, and the content of N is controlled below 800 ppm.

Furthermore, the content of O in the magnet is 0.05 wt. %-0.15 wt. %, and preferably 0.05 wt. %-0.10 wt. %, the content of C is 0.04 wt. %-0.1 wt. %, and preferably 0.04-0.08 wt. %; and the sum of the content of O and the content of C is 0.09 wt. %-0.25 wt. %, and preferably 0.10 wt. %-0.20 wt. %.

In the present disclosure, Mg can be added as an elemental raw material or as an alloy with other elements such as Al to form a MgAl alloy, as long as the final magnet contains the necessary amount of Mg.

Preferably, in the Mg-containing high-performance neodymium-iron-boron magnet, a phase region rich in Mg and Ga exists in a triangular grain boundary region among the main phase R₂T₁₄B, [Mg] is 0.18 wt. %-0.5 wt. %, 3.0 wt. %≤[Mg]+[Ga]≤6.0 wt. %, and 10≤[Ga]:[Mg]≤20. [Mg] represents the percentage of the mass of Mg in the triangular grain boundary region to the mass of all elements in the triangular grain boundary region, [Ga] represents the percentage of the mass of Ga in the triangular grain boundary region to the mass of all elements in the triangular grain boundary region, and [Mg]+[Ga] represents the percentage of the total mass of Mg and Ga in the triangular grain boundary region to the mass of all elements in the triangular grain boundary region.

Preferably, in the Mg-containing high-performance neodymium-iron-boron magnet, the content of Ga is 0.2 wt. %-0.7 wt. %, the content of Cu is 0.10 wt. %-0.50 wt. %, and the total mass of Ga and Cu is 0.2 wt. %-1.0 wt. %.

Preferably, in the Mg-containing high-performance neodymium-iron-boron magnet, R is one or more selected from rare earth elements and contains at least one of Nd or Pr; more preferably, R is at least two of Nd, Pr, Dy, and Tb, and more than 70% of R is Nd.

Preferably, the content of B is 0.88 wt. %-0.94 wt. %.

Preferably, the M1 must contain one or more high-melting point metal elements, which are Nb, Zr, Ti or W.

The preparation method for the Mg-containing high-performance neodymium-iron-boron magnet as described in the present disclosure comprises: taking raw materials of all elements according to a composition ratio, preparing SC strips by vacuum induction melting and strip spinning, performing hydrogen decrepitation and jet milling on the SC strips to obtain alloy powder, performing press-molding in an oriented magnetic field and cold isostatic pressing on the alloy powder to prepare a magnet compact, and performing vacuum sintering and high-temperature e diffusion treatment to obtain the Mg-containing high-performance neodymium-iron-boron magnet.

Furthermore, preferably, the D50 of the alloy powder after jet milling satisfies: 4.0 microns<D50<5.4 microns.

A lubricant and an antioxidant can be added to the alloy powder after jet milling, and press-molded in an oriented magnetic field using a conventional commercially available lubricant or antioxidant for magnetic powder protection. The antioxidant can also be added before the jet milling. The amount of the lubricant added can be 0.03-0.1% of the mass of the alloy powder, and the amount of the antioxidant can be 0.03-0.15% of the mass of the alloy powder. In order to reduce the amounts of additives so as to minimize the introduction of carbon impurity, one embodiment of the present disclosure is to use fine powder with D50>4.0 microns to ensure the flowability of the powder and reduce its activity; at the same time, under the same oriented field, the powder can obtain the maximum rotational driving force to achieve a high orientation degree. When using additives such as lubricants and antioxidants, additives with high volatility and a low degreasing temperature are selected from known lubricants to achieve maximum removal of carbon element before high-temperature holding during sintering.

The preferred oriented magnetic field is 1.8-6 T, and the molding pressure is 5-7 MPa. After oriented molding, the compact can be further subjected to cold isostatic pressing at a pressure of 150-180 MPa. After oriented molding, the compact density is 3.6-4.5 g/cm³, and after cold isostatic pressing, the compact density is about 4.6 g/cm³.

From hydrogen decrepitation to entering a sintering furnace, the atmosphere for storage and transportation is a protective gas atmosphere, thereby controlling the content of oxygen of the magnet to a lower level.

The magnet is sintered densely using a vacuum sintering process in the present disclosure. The vacuum sintering process is as follows: under a vacuum degree of 10⁻³-10⁻⁴ Pa, the sintering temperature is 950-1150° C., and the temperature holding time is 3-24 hours. Then it is cooled to room temperature. Due to the discharge of additives and impurity gases in the low-temperature section of the heating process, the vacuum degree will significantly decrease during the heating process. When the vacuum degree decreases, the temperature holding process should be started to ensure that the additives are completely removed at the lowest possible temperature. After the vacuum degree is restored, the temperature is further increased to a target sintering temperature.

The high-temperature diffusion treatment involves performing first stage aging on the sintered magnet at 700-900° C. for a temperature holding period of 2-8 hours, and then cooling it to room temperature; and performing second stage aging on the magnet after the first stage aging at 400-650° C. for a temperature holding period of 2-8 hours.

The beneficial effects of the present disclosure are mainly reflected in that in the R-T-B-based rare earth permanent magnet of the present invention, by adding a specified amount of Mg and an appropriate amount of Cu and Ga, the residual magnetism and coercivity of the magnet are enhanced, and the squareness of the magnet is significantly improved. Moreover, the moderate addition of high-melting point elements significantly improves the performance of the magnet. In addition, it is necessary to control the content of oxygen and carbon in the magnet. When the content of oxygen and carbon is high, Mg compounds formed at the grain boundary cannot improve the coercivity of the magnet.

### BRIEF DESCRIPTION OF THE DRAWINGS

FIG. 1 shows a microstructure image of experimental samples 2 and 4.

FIG. 2 shows a microstructure image of an experimental sample 19.

FIG. 3 shows a microstructure image of an experimental sample 21.

FIG. 4 shows a microstructure image of an experimental sample 27.

FIG. 5 shows a test result graph of ICP MS on experimental samples No. 4 and No. 19.

### DETAILED DESCRIPTION OF THE INVENTION

The following detailed description of the embodiments of the present disclosure is intended to explain the present disclosure and should not be construed as limiting the present disclosure.

The present disclosure used vacuum induction melting and strip spinning to prepare alloy SC strips (spin strips). Raw materials with a purity of 99.9 wt. % or higher were taken according to a distribution ratio and placed in a crucible in order of melting point from high to low. The furnace was evacuated until the vacuum degree reached 10⁻³-10⁻⁴ Pa and the dew point was below −50° C. Afterwards, the furnace was filled with argon gas to reach a pressure of 30-50 kPa, and heated to 1480-1510° C. The raw materials were completely melted, and then kept at this temperature for 3-5 minutes. Afterwards, the temperature of the alloy liquid was lowered to 1440-1460° C., kept at this temperature, and casted. The rotational speed of a copper roller was adjusted to 70-75 revolutions per minute, then the crucible was rotated at a certain speed to transport the molten alloy liquid through an intermediate package to a cooling roller for solidification, and then the resultant was dropped onto a water-cooled plate for cooling, so as to obtain quick-solidified thin strips (spinning strips) with a thickness of about 0.3 mm and a microstructure mostly composed of columnar crystals.

An alloy powder was prepared from the SC strips by hydrogen decrepitation and jet milling. During the hydrogen decrepitation treatment, the hydrogen pressure inside a reaction vessel was generally 0.01-0.09 MPa. During a hydrogen absorption reaction, if the pressure inside the reactor changes by no more than 0.5% within 10 minutes, it indicated the end of hydrogen absorption. After the hydrogen absorption reaction was completed, the temperature was raised to 400-600° C. while vacuuming, and the temperature was kept for 2-6 hours to remove hydrogen gas from the alloy strips. Then, hydrogen decrepitated coarse powder was obtained by cooling. The obtained coarse powder was placed in a jet milling equipment, the nozzle pressure was adjusted to 0.6 MPa-0.8 MPa, and the coarse powder was driven to collide with each other through a high-speed gas for decrepitation. The gas used in the jet milling is an inert gas such as nitrogen, helium, and argon. A sorting wheel and a cyclone separator of the jet milling equipment were controlled to adjust the particle size of the powder. Preferably, D50<5.4 μm was measured by an airflow dispersion laser particle size analyzer.

After the jet milling, the magnetic powder was mixed evenly, a lubricant and an antioxidant were added to the alloy powder, and the resultant was press-molded in an oriented magnetic field using a conventional commercially available lubricant or antioxidant for magnetic powder protection. The antioxidant could also be added before the jet milling. The amount of the lubricant added can be 0.03-0.1% of the mass of the alloy powder, and the amount of the antioxidant can be 0.03-0.15% of the mass of the alloy powder. In order to reduce the amount of additives and minimize the introduction of carbon impurity, one embodiment of the present disclosure was to use fine powder with D50>4.0 microns to ensure the flowability of the powder and reduce its activity; at the same time, under the same oriented field, the powder could obtain a maximum rotational driving force to achieve high orientation. When using additives such as lubricants and antioxidants, additives with high volatility and a low degreasing temperature were selected from known lubricants to achieve maximum removal of carbon element before high-temperature holding during sintering.

The preferred oriented magnetic field was 1.8-6 T, and the molding pressure was 5-7 MPa. After oriented molding, the compact could be further subjected to cold isostatic pressing at a pressure of 150-180 MPa. After oriented molding, the compact density was 3.6-4.5 g/cm³, and after cold isostatic pressing, the compact density was about 4.6 g/cm³.

The magnet was sintered densely using a vacuum sintering process. The vacuum sintering process was as follows: under a vacuum degree of 10-3-104 Pa, the sintering temperature was 950-1150° C., and the temperature holding time was 3-24 h. Then it was cooled to room temperature. Due to the discharge of additives and impurity gases in the low-temperature section of the heating process, the vacuum degree would significantly decrease during the heating process. When the vacuum degree decreased, the temperature holding process should be started to ensure that the additives were completely removed at the lowest possible temperature. After the vacuum degree was restored, the temperature was further increased to a target sintering temperature.

The sintered magnet was subjected to first stage aging at 700-900° C. for a temperature holding period of 2-8 hours. Then, it was cooled to room temperature.

After the first stage aging, the magnet was subjected to second stage aging at 400-650° C. for 2-8 hours.

To improve the processing performance of the product, the cooling rate could be slowed down after heat treatment to reduce internal stress.

Samples were taken from the magnet using wire electrical discharge machining, double-end face milling, and coreless milling. The sample size was a cylinder of Φ10*10 mm, and the machining rate was moderately reduced to ensure the verticality, concentricity, and dimensional accuracy of the product. A NIM15000HA magnetic performance tester was used to test the performance of the magnet with a size of 20° C. and a diameter of Φ10*10 mm.

ICP-OES and ICP-MS were used in combination to measure the mass fraction of components above and below 0.1 wt. % respectively.

### Example 1

PrNd metal with a purity of 99.5 wt. % or more, Dy, Tb or an alloy thereof with a purity of 99.9 wt. % or more, electrolytic copper, electrical pure iron and low-carbon boron were used as main components, other trace elements were added in the form of pure metal or Fe alloy, Mg was added in the form of pure Mg, and the content of Mg in all raw materials except Mg raw material was less than 5 PPM. A 0.3 mm thick spin strip alloy was obtained by melting the spin strips.

The alloy was subjected to hydrogen absorption and decrepitation under a hydrogen pressure of 0.10 MPa and heated to 450° C. for dehydrogenation. After cooling, 0.03 wt. % of an antioxidant (Magnetic Powder Protective Antioxidant 3 #produced by Tianjin Yuesheng New Materials Research Institute) was added to a coarse alloy powder, and mixed for 3 hours. The coarse alloy powder was further decrepitated using nitrogen jet milling to obtain a fine powder with a D50 ranging from 4.6-4.8 microns.

0.08 wt. % of an organic lubricant (a lubricant produced by Ningbo Haotian Chemical) was added to the fine powder, and press-molded in a magnetic field. The oriented magnetic field was a static magnetic field of 1.8 T, and the pressing density was 3.9-4.1 g/cm³. After vacuum sealing the pressed blank, it was subjected to cold isostatic pressing and then loaded into a sintering furnace. From hydrogen decrepitation to entering a sintering furnace, the atmosphere for storage and transportation was a protective gas atmosphere, thereby controlling the content of oxygen of the magnet to a lower level.

The compact was sintered in a vacuum environment (10⁻³-10⁻⁴ Pa absolute vacuum degree) at 1050-1100° C. for 4.5 hours. The sintering temperature was slightly adjusted according to the composition, with a minimum requirement of density>7.5 g/cm³, and the grain size of the main phase should not exceed 15 microns. The sintering temperature was controlled by the vacuum degree. When the pressure inside the furnace was greater than 0.01 Pa, the temperature holding process should be started to ensure that additives were completely removed at the lowest possible temperature. After the vacuum degree was restored, it was further heated to a target sintering temperature. After sintering, an internal fan was turned on to force cooling to room temperature. Then the temperature was raised, the magnet was held at 900° C. for 3 hours and then cooled to room temperature, then the magnet was held at 500° C. for 4 h and cooled to complete the heat treatment, and argon gas was introduced for cooling.

The content of each element was tested using ICP, while the content of C was measured using a carbon sulfur analyzer, and the content was expressed as a mass percentage. The magnet compositions of Experiments Nos. 1-14 were shown in Table 1:

TABLE 1

| No. | Nd | Pr | Dy | Tb | Fe | B | Al | Co | Cu | Ga | Mg | Zr | O | C |
|---|---|---|---|---|---|---|---|---|---|---|---|---|---|---|
| 1 | 23.8 | 6.8 | 0 | 0 | Bal | 0.92 | 0 | 0.5 | 0.15 | 0.35 | 0.0003 | 0.15 | 0.08 | 0.05 |
| 2 | 23.8 | 6.8 | 0 | 0 | Bal | 0.92 | 0 | 0.5 | 0.15 | 0.35 | 0.0005 | 0.15 | 0.08 | 0.05 |
| 3 | 23.8 | 6.8 | 0 | 0 | Bal | 0.92 | 0 | 0.5 | 0.15 | 0.35 | 0.0010 | 0.15 | 0.08 | 0.05 |
| 4 | 23.8 | 6.8 | 0 | 0 | Bal | 0.92 | 0 | 0.5 | 0.15 | 0.35 | 0.0012 | 0.15 | 0.08 | 0.05 |
| 5 | 23.8 | 6.8 | 0 | 0 | Bal | 0.92 | 0 | 0.5 | 0.15 | 0.35 | 0.0016 | 0.15 | 0.08 | 0.05 |
| 6 | 23.8 | 6.8 | 0 | 0 | Bal | 0.92 | 0 | 0.5 | 0.15 | 0.35 | 0.0020 | 0.15 | 0.08 | 0.05 |
| 7 | 23.8 | 6.8 | 0 | 0 | Bal | 0.92 | 0 | 0.5 | 0.15 | 0.35 | 0.0025 | 0.15 | 0.08 | 0.05 |
| 8 | 23.8 | 6.8 | 0 | 0 | Bal | 0.92 | 0 | 0.5 | 0.15 | 0.35 | 0.0050 | 0.15 | 0.08 | 0.05 |
| 9 | 23.02 | 6.58 | 1.0 | 0 | Bal | 0.92 | 0 | 0.5 | 0.15 | 0.35 | 0.0010 | 0.15 | 0.08 | 0.05 |
| 10 | 23.41 | 6.69 | 0 | 0.5 | Bal | 0.92 | 0 | 0.5 | 0.15 | 0.35 | 0.0010 | 0.15 | 0.08 | 0.05 |
| 11 | 24.58 | 7.02 | 0 | 0 | Bal | 0.92 | 0 | 0.5 | 0.15 | 0.35 | 0.0010 | 0.15 | 0.08 | 0.05 |
| 12 | 23.8 | 6.8 | 0 | 0 | Bal | 0.92 | 0.2 | 0.5 | 0.15 | 0.35 | 0.0010 | 0.15 | 0.08 | 0.05 |
| 13 | 23.8 | 6.8 | 0 | 0 | Bal | 0.92 | 0.2 | 0 | 0.15 | 0.35 | 0.0010 | 0.15 | 0.08 | 0.05 |
| 14 | 23.8 | 6.8 | 0 | 0 | Bal | 0.92 | 0 | 0.5 | 0.15 | 0.35 | 0.0010 | 0 | 0.08 | 0.05 |

Samples were taken from the magnet using wire electrical discharge machining, double-end face milling, and coreless milling. The sample size was a cylinder of Φ10*10 mm. NIM16000 was used to test the demagnetization curve of the samples and obtain Br, Hcj, and SQ, the performance was shown in Table 2 below:

TABLE 2

| No. | Br/KGs | Hcj/KOe | Hk/KOe | SQ |
|---|---|---|---|---|
| 1 | 14.35 | 15.02 | 13.86 | 92.3% |
| 2 | 14.38 | 15.26 | 14.54 | 95.3% |
| 3 | 14.42 | 15.53 | 15.08 | 97.1% |
| 4 | 14.43 | 15.63 | 15.43 | 98.7% |
| 5 | 14.41 | 15.48 | 14.98 | 96.8% |
| 6 | 14.37 | 15.32 | 14.58 | 95.2% |
| 7 | 14.34 | 14.83 | 13.91 | 93.8% |
| 8 | 14.31 | 14.20 | 13.02 | 91.7% |
| 9 | 14.15 | 16.85 | 16.48 | 97.8% |
| 10 | 14.23 | 16.48 | 16.18 | 98.2% |
| 11 | 14.15 | 15.86 | 15.30 | 96.5% |
| 12 | 14.21 | 15.72 | 15.28 | 97.2% |
| 13 | 14.35 | 15.68 | 15.18 | 96.8% |
| 14 | 14.38 | 13.65 | 12.11 | 88.7% |

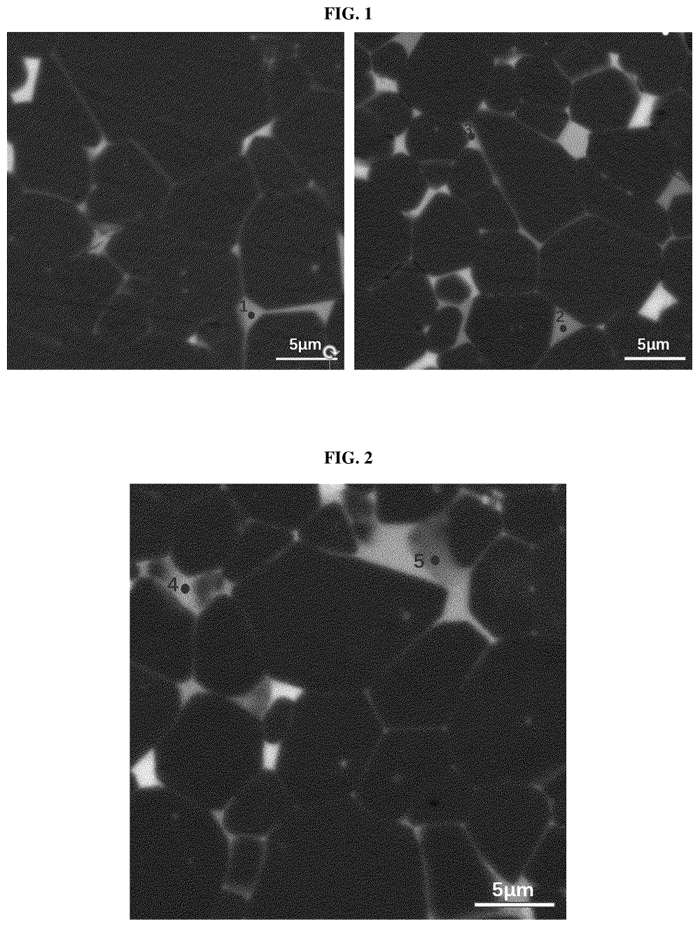

SEM (Japan Electronics Corporation (JEOL)) and EDS were used to observe the cross-sectional microstructure and grain boundary phase composition of the magnet, the special microstructures of samples 2 and 4 were shown in FIG. 1. In FIG. 1, the left image showed sample 2 and the right image showed sample 4. The grain boundary phase composition in the figure was shown in Table 3 below:

TABLE 3

| | | Nd | Pr | Fe | Cu | Ga | Mg |
|---|---|---|---|---|---|---|---|
| Energy | Element | L line | L line | K line | L line | L line | K line |
| spectrum | Line type | system | system | system | system | system | system |
| 1 | Mass | 42.78 | 12.22 | 40.09 | 0.12 | 4.6 | 0.19 |
| | percentage | | | | | | |
| 2 | Mass | 38.39 | 14.48 | 41.37 | 0.22 | 5.11 | 0.43 |
| | percentage | | | | | | |
| 3 | Mass | 35.43 | 12.69 | 46.36 | 0.25 | 4.88 | 0.39 |
| | percentage | | | | | | |

It could be determined that the grain boundary phase between the main phases contained a Mg-rich region with a content of Mg of 0.19 wt. %-0.43 wt. %.

Based on the energy spectrum of a Mg-rich grain boundary phase and the magnetic performance of sample Nos. 1-5, it could be concluded that Mg could combine with Ga to form various intermediate compounds with good wettability, which was conducive to the formation of continuous grain boundary phases, thereby improving the coercivity and squareness of the magnet.

Conclusion: when an appropriate amount of Mg (greater than 0.0005 wt. % and less than 0.002 wt. %) was added, the Hcj of the magnet was slightly increased, and the SQ was increased significantly. At the same time, the addition of a small amount of Mg did not affect the addition effect of other elements. For example, adding a certain amount of Dy and Tb would increase the coercivity and directionality, and correspondingly decrease the residual magnetism. Moreover, the addition of high-melting point Zr element significantly improved the performance of the magnet.

### Example 2

PrNd metal with a purity of 99.5 wt. % or more, Dy, Tb or an alloy thereof with a purity of 99.9 wt. % or more, electrolytic copper, electrical pure iron and low-carbon boron were used as main components, other trace elements were added in the form of pure metal or Fe alloy, Mg was added in the form of pure Mg, and the content of Mg in all raw materials except Mg raw material was less than 5 PPM. A 0.3 mm thick spin strip alloy was obtained by melting the spin strips.

The alloy was subjected to hydrogen absorption and decrepitation under a hydrogen pressure of 0.10 MPa and heated to 450° C. for dehydrogenation. After cooling, 0.03 wt. % of an antioxidant (Magnetic Powder Protective Antioxidant 3 #produced by Tianjin Yuesheng New Materials Research Institute) was added to a coarse alloy powder, and mixed for 3 hours. The coarse alloy powder was further decrepitated using nitrogen jet milling to obtain a fine powder with a D50 ranging from 4.6-4.8 microns.

0.08 wt. % of an organic lubricant (a lubricant produced by Ningbo Haotian Chemical) was added to the fine powder, and press-molded in a magnetic field. The oriented magnetic field was a static magnetic field of 1.8 T, and the pressing density was 3.9-4.1 g/cm³. After vacuum sealing the pressed blank, it was subjected to cold isostatic pressing and then loaded into a sintering furnace. From hydrogen decrepitation to entering a sintering furnace, the atmosphere for storage and transportation was a protective gas atmosphere, thereby controlling the content of oxygen of the magnet to a lower level.

The compact was sintered in a vacuum environment at 1050-1100° C. for 4.5 hours. The sintering temperature was slightly adjusted according to the composition, with a minimum requirement of density>7.5 g/cm³, and the grain size of the main phase should not exceed 15 microns. The sintering temperature was controlled by the vacuum degree. When the pressure inside the furnace was greater than 0.01 Pa, the temperature holding process should be started to ensure that additives were completely removed at the lowest possible temperature. After the vacuum degree was restored, it was further heated to a target sintering temperature. After sintering, an internal fan was turned on to force cooling to room temperature. Then the temperature was raised, the magnet was held at 900° C. for 3 hours and then cooled to room temperature, then the magnet was held at 500° C. for 4 hours and cooled to complete the heat treatment, and argon gas was introduced for cooling.

The content of each element was tested using ICP, and the content of C was measured using a carbon sulfur analyzer and expressed as a mass percentage. The magnet compositions of Experiments Nos. 15-24 were shown in Table 4:

TABLE 4

| No. | Nd | Pr | Fe | B | Co | Cu | Ga | Mg | Zr | O | C |
|---|---|---|---|---|---|---|---|---|---|---|---|
| 15 | 24.1 | 6.9 | Bal | 0.94 | 0.5 | 0 | 0.15 | 0.0015 | 0.15 | 0.08 | 0.05 |
| 16 | 24.1 | 6.9 | Bal | 0.94 | 0.5 | 0 | 0.35 | 0.0015 | 0.15 | 0.08 | 0.05 |
| 17 | 24.1 | 6.9 | Bal | 0.94 | 0.5 | 0 | 0.70 | 0.0015 | 0.15 | 0.08 | 0.05 |
| 18 | 24.1 | 6.9 | Bal | 0.94 | 0.5 | 0.1 | 0.35 | 0.0015 | 0.15 | 0.08 | 0.05 |
| 19 | 24.1 | 6.9 | Bal | 0.94 | 0.5 | 0.25 | 0.35 | 0.0015 | 0.15 | 0.08 | 0.05 |
| 20 | 24.1 | 6.9 | Bal | 0.94 | 0.5 | 0.50 | 0.35 | 0.0015 | 0.15 | 0.08 | 0.05 |
| 21 | 24.1 | 6.9 | Bal | 0.94 | 0.5 | 0.20 | 0.40 | 0.0015 | 0.15 | 0.08 | 0.05 |
| 22 | 24.1 | 6.9 | Bal | 0.94 | 0.5 | 0.30 | 0.50 | 0.0015 | 0.15 | 0.08 | 0.05 |
| 23 | 24.1 | 6.9 | Bal | 0.94 | 0.5 | 0.40 | 0.60 | 0.0015 | 0.15 | 0.08 | 0.05 |
| 24 | 24.1 | 6.9 | Bal | 0.94 | 0.5 | 0.50 | 0.70 | 0.0015 | 0.15 | 0.08 | 0.05 |

Samples were taken from the magnet using wire electrical discharge machining, double-end face milling, and coreless milling. The sample size was a cylinder of Φ10*10 mm. NIM16000 was used to test the demagnetization curve of the samples and obtain Br, Hcj, and SQ, and the performance was shown in Table 5 below:

TABLE 5

| No. | Br/KGs | Hcj/KOe | Hk/KOe | SQ |
|---|---|---|---|---|
| 15 | 14.45 | 14.62 | 13.93 | 95.3% |
| 16 | 14.39 | 16.13 | 15.52 | 96.2% |
| 17 | 14.25 | 17.73 | 16.33 | 92.1% |
| 18 | 14.37 | 17.52 | 17.20 | 98.2% |
| 19 | 14.36 | 18.45 | 18.04 | 97.8% |
| 20 | 14.15 | 16.24 | 15.46 | 95.2% |
| 21 | 14.34 | 18.03 | 17.54 | 97.3% |
| 22 | 14.21 | 18.35 | 17.47 | 95.2% |
| 23 | 14.05 | 17.31 | 14.46 | 81.2% |
| 24 | 13.87 | 16.13 | 15.31 | 89.4% |

SEM (Japan Electronics Corporation (JEOL)) and EDS were used to observe the cross-sectional microstructure and grain boundary phase composition of the magnet, the microstructure of sample 19 was shown in FIG. 2, and the grain boundary phase composition was shown in Table 6 below:

TABLE 6

| | | Nd | Pr | Fe | Cu | Ga | Mg |
|---|---|---|---|---|---|---|---|
| Energy | Element | L line | L line | K line | L line | L line | K line |
| spectrum | Line type | system | system | system | system | system | system |
| 4 | Mass | 38.8 | 14.44 | 41.22 | 0.27 | 4.79 | 0.48 |
| | percentage | | | | | | |
| 5 | Mass | 38.44 | 18.47 | 39.13 | 0.17 | 3.52 | 0.27 |
| | percentage | | | | | | |

It could be determined that the grain boundary phase between the main phases contained a Mg-rich region with a content of Mg of 0.27 wt. %-0.48 wt. %.

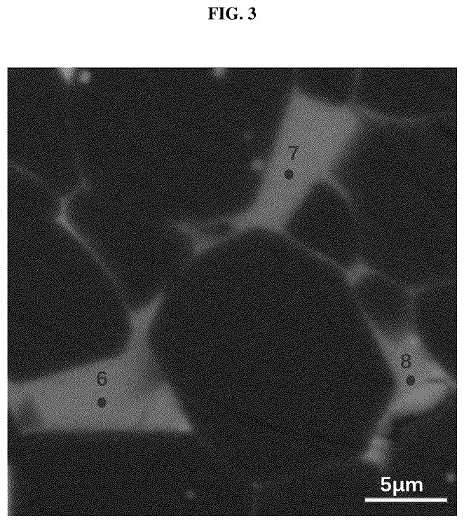

The special microstructure of sample 21 was shown in FIG. 3, and the grain boundary phase composition was shown in Table 7 below:

TABLE 7

| | | Nd | Pr | Fe | Cu | Ga | Mg |
|---|---|---|---|---|---|---|---|
| Energy | Element | L line | L line | K line | L line | L line | K line |
| spectrum | Line type | system | system | system | system | system | system |
| 6 | Mass | 36.90 | 13.39 | 44.40 | 0.15 | 4.81 | 0.35 |
| | percentage | | | | | | |
| 7 | Mass | 38.83 | 15.29 | 40.91 | 0.17 | 4.38 | 0.42 |
| | percentage | | | | | | |
| 8 | Mass | 38.48 | 15.14 | 41.18 | 0.18 | 4.57 | 0.45 |
| | percentage | | | | | | |

It could be determined that the grain boundary phase between the main phases contained a Mg-rich region with a content of Mg of 0.35 wt. %-0.45 wt. %.

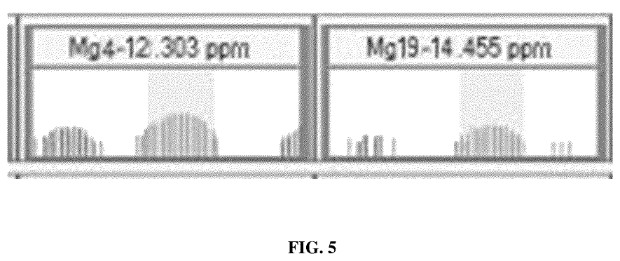

A test result graph of ICP-MS on samples Nos. 4 and 19 were shown in FIG. 5. In FIG. 5, the left image Mg4 represented sample No. 4, and the measured content of Mg was 12.303 ppm, which was consistent with the added amount of 12 ppm of Mg.

The right image Mg19 represented sample No. 19, and the measured content of Mg was 14.455 ppm, which was basically close to the addition amount of 15 ppm.

Cu and Ga elements could improve the wettability between the grain boundary phase and the main phase, thereby facilitating a more uniform distribution of the grain boundary phase. At the same time, they could encapsulate a Mg compound at the grain boundary and avoided direct contact of the Mg compound with the main phase, thereby increasing the coercivity of the magnet. The magnetic performance of sample Nos. 16-22 indicated that adding appropriate amounts of Cu and Ga under the conditions of forming the Mg compound could simultaneously increase the residual magnetism and coercivity of the magnet.

Conclusion: although a content of 0.0015 wt. % of Mg was added, when the sum of the content of Ga and Cu was less than 0.2 wt. %, the optimization of the coercivity and squareness of the magnet did not yield good results. When the sum of the content of Ga and Cu was greater than 1 wt. %, the residual magnetism and coercivity decreased significantly, and the property fluctuation increased. According to SEM analysis, it was found that excessive Ga and Cu could easily lead to the formation of large Ga- and Cu-rich phases, which increased the local stray field and demagnetization field, resulting in performance deterioration.

### Example 3

PrNd metal with a purity of 99.5 wt. % or more, Dy, Tb or an alloy thereof with a purity of 99.9 wt. % or more, electrolytic copper, electrical pure iron and low-carbon boron were used as main components, other trace elements were added in the form of pure metal or Fe alloy, Mg was added in the form of pure Mg, and the content of Mg in all raw materials except Mg raw material was less than 5 PPM. A 0.3 mm thick spin strip alloy was obtained by melting the spin strips.

The alloy was subjected to hydrogen absorption and decrepitation under a hydrogen pressure of 0.10 MPa and heated to 550° C. for dehydrogenation. After cooling, 0.03 wt. % of an antioxidant (Magnetic Powder Protective Antioxidant 3 #produced by Tianjin Yuesheng New Materials Research Institute) was added to a coarse alloy powder, and mixed for 3 hours. The coarse alloy powder was further decrepitated using nitrogen jet milling to obtain a fine powder with a D50 ranging from 4.6-4.8 microns. The oxygen supplementation process was simultaneously adjusted during the jet milling stage to achieve different contents of oxygen in the sintered blank.

0.08 wt. % and 0.15 wt. % of an organic lubricant (a lubricant produced by Ningbo Haotian Chemical) was added to the fine powder respectively, and mixed for 3 h, and a small amount of NdO was added to some fine powder samples to control the different contents of C and O in the sintered blank. It was pressed into shape in a magnetic field. An oriented magnetic field was a static magnetic field of 1.8 T, and a pressing density was 3.9-4.1 g/cm.

The compact was sintered in a vacuum environment at 1050-1100° C. for 4.5 hours. The sintering temperature was slightly adjusted according to the composition, with a minimum requirement of density>7.5 g/cm³, and the grain size of the main phase should not exceed 15 microns. The sintering temperature was controlled by the vacuum degree. When the pressure inside the furnace was greater than 0.01 Pa, the temperature holding process should be started to ensure that additives were completely removed at the lowest possible temperature. After the vacuum degree was restored, it was further heated to a target sintering temperature. After sintering, an internal fan was turned on to force cooling to room temperature. Then the temperature was raised, the magnet was held at 900° C. for 3 hours and then cooled to room temperature, then the magnet was held at 500° C. for 4 hours and cooled to complete the heat treatment, and argon gas was introduced for cooling.

The content of each element was tested using ICP, and the content of C was measured using a carbon sulfur analyzer and expressed as a mass percentage. The magnet compositions of Experiments Nos. 25-30 were shown in Table 8:

TABLE 8

| No. | Nd | Pr | Fe | B | Co | Cu | Ga | Mg | Zr | O | C |
|---|---|---|---|---|---|---|---|---|---|---|---|
| 25 | 24.9 | 7.1 | Bal | 0.92 | 0.5 | 0.15 | 0.25 | 0.0017 | 0.15 | 0.05 | 0.05 |
| 26 | 24.9 | 7.1 | Bal | 0.92 | 0.5 | 0.15 | 0.25 | 0.0017 | 0.15 | 0.10 | 0.05 |
| 27 | 24.9 | 7.1 | Bal | 0.92 | 0.5 | 0.15 | 0.25 | 0.0017 | 0.15 | 0.15 | 0.05 |
| 28 | 24.9 | 7.1 | Bal | 0.92 | 0.5 | 0.15 | 0.25 | 0.0017 | 0.15 | 0.10 | 0.07 |
| 29 | 24.9 | 7.1 | Bal | 0.92 | 0.5 | 0.15 | 0.25 | 0.0017 | 0.15 | 0.10 | 0.10 |
| 30 | 24.9 | 7.1 | Bal | 0.92 | 0.5 | 0.15 | 0.25 | 0.0017 | 0.15 | 0.15 | 0.10 |

Samples were taken from the magnet using wire electrical discharge machining, double-end face milling, and coreless milling. The sample size was a cylinder of Φ10*10 mm. NIM16000 was used to test the demagnetization curve of the samples and obtain Br, Hcj, and SQ, and the performance was shown in Table 9 below:

TABLE 9

| No. | Br/KGs | Hcj/KOe | Hk/KOe | SQ |
|---|---|---|---|---|
| 25 | 13.65 | 16.82 | 16.57 | 98.5% |
| 26 | 13.59 | 17.53 | 17.28 | 98.6% |
| 27 | 13.35 | 17.03 | 16.04 | 94.2% |
| 28 | 13.47 | 17.19 | 16.35 | 95.1% |
| 29 | 13.36 | 16.65 | 15.60 | 93.7% |
| 30 | 13.16 | 16.24 | 14.45 | 89.0% |

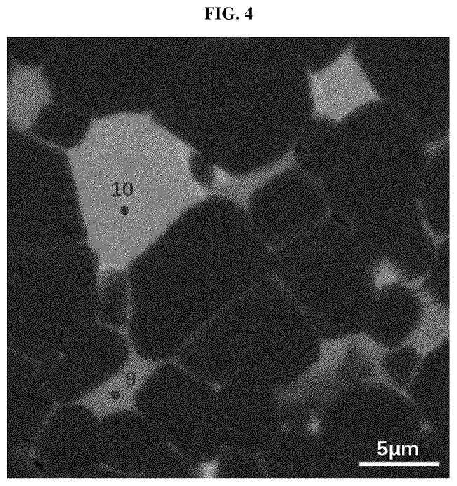

SEM (Japan Electronics Corporation (JEOL)) and EDS were used to observe the cross-sectional microstructure and grain boundary phase composition of the magnet, the special microstructure of sample 27 was shown in FIG. 4, and the grain boundary phase composition was shown in Table 10 below:

TABLE 10

| | | Nd | Pr | Fe | Cu | Ga | Mg | O |
|---|---|---|---|---|---|---|---|---|
| Energy | Element | L line | L line | K line | L line | L line | K line | K line |
| spectrum | Line type | system | system | system | system | system | system | system |
| 9 | Mass | 38.45 | 14.95 | 41.43 | 0.23 | 4.53 | 0.41 | |
| | percentage | | | | | | | |
| 10 | Mass | 52.21 | 16.40 | 19.91 | | | | 11.48 |
| | percentage | | | | | | | |

It could be determined that the grain boundary phase between the main phases contained a Mg-rich region with a content of Mg of 0.41 wt. %.

At the same time, due to the addition of a small amount of NdO in the samples, the content of oxygen of the magnet increased, and large pieces of Nd₂Oₓ compounds appeared in the grain boundary, resulting in a decrease in Hcj and squareness of the magnet. Carbon reacted with rare earth elements at the grain boundary phase to form carbides, reducing the content of rare earth-rich phase at the grain boundary and lowering the coercivity of the magnet. By combining the energy spectrum with the magnetic performance of magnet Nos. 27-30, it could be concluded that when the content of oxygen and carbon was high, Mg compounds formed at the grain boundary could not improve the coercivity of the magnet.

1. An Mg-containing high-performance neodymium-iron-boron magnet, wherein the raw material composition of the magnet comprises the following components in percentages by mass:
29.0 wt. %-32.0 wt. % of R, wherein R is one or more selected from rare earth elements and contains at least one of Nd or Pr;
0.05 wt. %-2.0 wt. % of M1, wherein M1 is one or more of Al, Mn, Nb, Ti, W, Hf, Zr or Cr;
0.2 wt. %-1.0 wt. % of M2, wherein M2 is Ga or Ga and Cu;
0.85 wt. %-0.96 wt. % of B;
0.0005 wt. %-0.002 wt. % of Mg;
the balance of T, wherein T is Fe or Fe and Co, and 90% or more of T is Fe; and
other inevitable impurities.

2. The Mg-containing high-performance neodymium-iron-boron magnet of claim 1, wherein the contents of B and T in the magnet satisfy the following relationship:
$$14 [ B ] / 10.8 \leq [ T ] / 55.85$$
wherein [B] is the content of B expressed in mass %, and [T] is the content of T expressed in mass %.

3. The Mg-containing high-performance neodymium-iron-boron magnet of claim 1, wherein the oxygen content of the magnet is controlled below 1500 ppm, the C content is controlled below 1200 ppm, and the N content is controlled below 800 ppm.

4. The Mg-containing high-performance neodymium-iron-boron magnet of claim 3, wherein the content of O in the magnet is 0.05 wt. %-0.15 wt. %, the content of C is 0.04 wt. %-0.1 wt. %, and the sum of the content of O and the content of C is 0.09 wt. %-0.25 wt. %.

5. The Mg-containing high-performance neodymium-iron-boron magnet of claim 1, wherein in the Mg-containing high-performance neodymium-iron-boron magnet, a phase region rich in Mg and Ga exists in a triangular grain boundary region among the magnet main phase R₂T₁₄B, [Mg] is 0.18 wt. %-0.5 wt. %, 3.0 wt. %≤[Mg]+ [Ga]≤6.0 wt. %, and 10≤[Ga]:[Mg]≤20; wherein [Mg] represents the percentage of the mass of Mg in the triangular grain boundary region to the mass of all elements in the triangular grain boundary region, [Ga] represents the percentage of the mass of Ga in the triangular grain boundary region to the mass of all elements in the triangular grain boundary region, and [Mg]+ [Ga] represents the percentage of the total mass of Mg and Ga in the triangular grain boundary region to the mass of all elements in the triangular grain boundary region.

6. The Mg-containing high-performance neodymium-iron-boron magnet of claim 1, wherein in the Mg-containing high-performance neodymium-iron-boron magnet, the content of Ga is 0.2 wt. %-0.7 wt. %, the content of Cu is 0.10 wt. %-0.50 wt. %, and the total mass of Ga and Cu is 0.2 wt. %-1.0 wt. %.

7. The Mg-containing high-performance neodymium-iron-boron magnet of claim 1, wherein the content of B is 0.88 wt. %-0.94 wt. %.

8. The Mg-containing high-performance neodymium-iron-boron magnet of claim 1, wherein in the Mg-containing high-performance neodymium-iron-boron magnet, M1 must contain one or more high-melting point metal elements, and the high-melting point metal element is Nb, Zr, Ti or W.

9. A preparation method for the Mg-containing high-performance neodymium-iron-boron magnet of claim 1, wherein the method comprises: taking raw materials of all elements according to a composition ratio, preparing SC strips by vacuum induction melting and strip spinning, performing hydrogen decrepitation and jet milling to the SC strips to obtain an alloy powder, performing press-molding in an oriented magnetic field and cold isostatic pressing on the alloy powder to prepare a magnet compact, and performing vacuum sintering and high-temperature diffusion treatment to obtain the Mg-containing high-performance neodymium-iron-boron magnet.

10. The method of claim 9, wherein the D50 of the alloy powder after jet milling satisfies: 4.0 microns<D50<5.4 microns.
